(19) United States
(12) Patent Application Publication
(10) Pub. No.: US 2007/0118487 A1
(43) Pub. Date: May 24, 2007

(54) Product cost modeling method and system

(75) Inventors: Anthony J. Grichnik, Peoria, IL (US); Michael Seskin, Cardiff, CA (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/281,748

(22) Filed: Nov. 18, 2005

(51) Int. Cl. G06F 17/00

(52) U.S. Cl. 705/400

(57) ABSTRACT

A method is provided for a product cost modeling system. The method may include establishing a product cost process model indicative of interrelationships between product costs of one or more existing products and a respective plurality of characteristic parameters of the existing products. The method may also include obtaining a set of values corresponding to a plurality of characteristic parameters of a target product from a data source and calculating the product cost of the target product based upon the set of values corresponding to the plurality of characteristic parameters of the target product and the product cost process model.

### TECHNICAL FIELD

This disclosure relates generally to computer based process modeling techniques and, more particularly, to methods and systems for modeling product cost.

### BACKGROUND

Product cost may be calculated or predicted based on product data on materials and process plans by various traditional techniques. Certain techniques may use manufacturing data, standards, and extensive databases to produce cost estimates and process plans based on mathematical algorithms or models. Such models may be used to provide computerized cost estimating and process planning for manufacturing.

Certain models may have the ability to provide instant estimating through databases of available historical data. These models may also be able to calculate time and cost per piece to manufacture based on the historical data. On the other hand, product cost of a product that is still in a design process may be estimated differently. More particularly, in the design process of a new product, historical data of the new product may be unavailable.

In the absence of the historical data of products in the design process, or where the historical data is significantly different than the desired products, process-oriented approaches may be used. For example, U.S. Pat. No. 6,775,647 to Evans et al. (the '647 patent) discloses a technique for developing a method and system for estimating manufacturing costs for conventional and advanced materials and process plans. The '647 patent discloses a cost model derived from a set of discrete point estimates, these point estimates representing variations that impact the cost of a product consisting of different configurations and designs, alternative materials, and possibly different methods of manufacturing. However, such conventional techniques often fail to address inter-correlation between individual variations, especially at the time of generation and/or optimization of computational models, or to correlate the variations to the cost simultaneously.

Methods and systems consistent with certain features of the disclosed systems are directed to solving one or more of the problems set forth above.

### SUMMARY OF THE INVENTION

One aspect of the present disclosure includes a method for a product cost modeling system. The method may include establishing a product cost process model indicative of interrelationships between product costs of one or more existing products and a respective plurality of characteristic parameters of the existing products. The method may also include obtaining a set of values corresponding to a plurality of characteristic parameters of a target product from a data source and calculating the product cost of the target product based upon the set of values corresponding to the plurality of characteristic parameters of the target product and the product cost process model.

Another aspect of the present disclosure includes a computer system. The computer system may include a database containing data records associating product costs of one or more existing products and a respective plurality of characteristic parameters of the existing products. The computer system may also include a data source and a processor. The processor may be configured to obtain a set of values corresponding to a plurality of characteristic parameters of a target product from the data source and to calculate the product cost of the target product based upon the set of values corresponding to the plurality of characteristic parameters of the target product and the product cost process model. The processor may also be configured to present the product cost of the target product to the data source; to determine a desired product cost range of the target product; and to modify the plurality of characteristic parameters of the target product simultaneously such that an actual product cost of the target product is within the desired product cost range.

Another aspect of the present disclosure includes a computer-readable medium for use on a computer system configured to perform a product cost predicting procedure. The computer-readable medium may include computer-executable instructions for performing a method. The method may include establishing a product cost process model indicative of interrelationships between product costs of one or more existing products and a respective plurality of characteristic parameters of the existing products. A set of values is obtained corresponding to a plurality of characteristic parameters of a target product from a data source. The method may also include calculating the product cost of the target product based upon the set of values corresponding to the plurality of characteristic parameters of the target product and the product cost process model. The product cost of the target product is presented to the data source.

### BRIEF DESCRIPTION OF THE DRAWINGS

FIG. 1 illustrates a block diagram of an exemplary product cost process modeling environment consistent with certain disclosed embodiments;

FIG. 2 illustrates a block diagram of a computer system consistent with certain disclosed embodiments;

FIG. 3 illustrates a flowchart of an exemplary product cost process model generation and optimization process consistent with certain disclosed embodiments; and

FIG. 4 shows an exemplary operational process consistent with certain disclosed embodiments.

### DETAILED DESCRIPTION

Reference will now be made in detail to exemplary embodiments, which are illustrated in the accompanying drawings. Wherever possible, the same reference numbers will be used throughout the drawings to refer to the same or like parts.

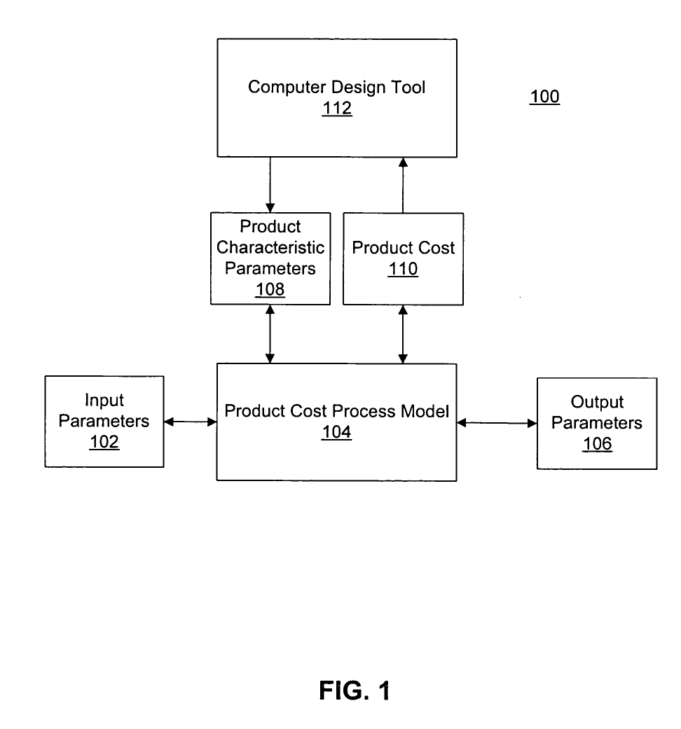

FIG. 1 illustrates a block diagram of an exemplary product cost process modeling environment 100. As shown in FIG. 1, a product cost process model 104 may be established to build interrelationships between input parameters 102 and output parameters 106. After product cost process model 104 is established, values of input parameters 102 may be provided to product cost process model 104 to predict values of output parameters 106 based on the given values of input parameters 102 and the interrelationships established by product cost process model 104.

Further, product cost process modeling environment 100 may include a computer design tool 112, such as CAD (computer aided design), etc. Computer design tool 112 may use an established product cost process model 104 to obtain cost information about a product (e.g., a single part, a component of multiple parts, an assembly, or a complete manufacturing item, etc.). The product may be new and may be still in a design phase, or the product may have existed and may be modified by computer design tool 112. Computer design tool 112 may provide product characteristic parameters 108 of the product to product cost model 104. Compute design tool 112 may also receive product cost 110 from product cost process model 104 based on product characteristic parameters 108 and the interrelationships between input parameters 102 and output parameters 106 that has been built by product cost process model 104.

When used in establishing product cost process model 104, input parameters 102 may include any appropriate type of data associated with a particular design application. For example, input parameters 102 may include characteristic data of a large number of existing products associated with known costs. Such characteristic data may include, for example, dimensional variables, geometrical variables, material types, and/or design information, etc. Output parameters 106, on the other hand, may correspond to cost of the products, or any other types of output parameters used by the particular design application.

Product cost process model 104 may include any appropriate type of mathematical or physical model indicating interrelationships between input parameters 102 and output parameters 106. For example, product cost process model 104 may be a neural network based mathematical model that is trained to capture interrelationships between input parameters 102 and output parameters 106. Other types of mathematic models, such as fuzzy logic models, linear system models, and/or non-linear system models, etc., may also be used. Product cost process model 104 may be trained and validated using data records collected from a particular application for which product cost process model 104 is established. That is, product cost process model 104 may be established according to particular rules corresponding to a particular type of model using the data records, and the interrelationships of product cost process model 104 may be verified by using part of the data records.

After product cost process model 104 is trained and validated, product cost process model 104 may be optimized to define a desired input space of input parameters 102 and/or a desired distribution of output parameters 106. The validated or optimized product cost process model 104 may used to produce corresponding values of output parameters 106 when provided with a set of values of input parameters 102. For example, as explained above, computer design tool 112 may use product cost process model 104 to derive product cost 110 of a product under design from product characteristic parameters 108 provided to product cost process model 104.

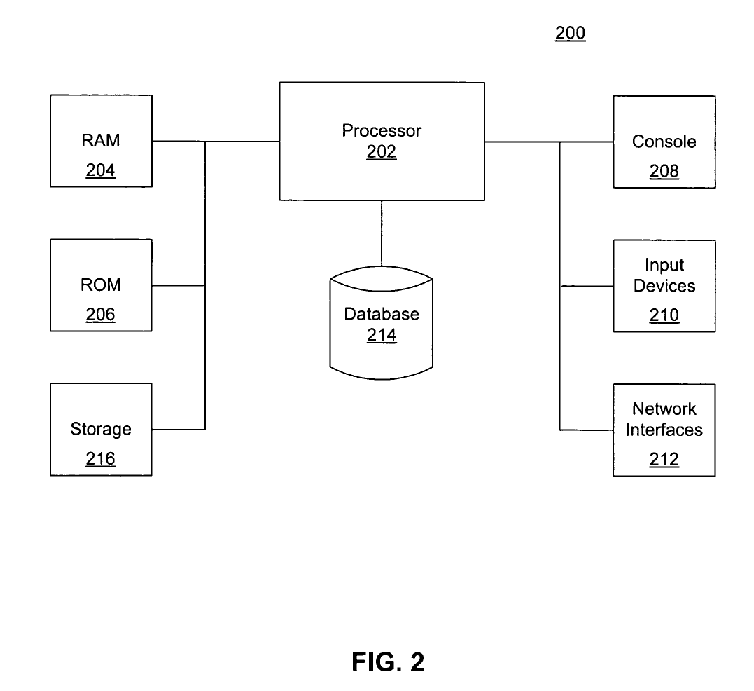

The establishment and operations of product cost process model 104 may be carried out by one or more computer systems. FIG. 2 shows a functional block diagram of an exemplary computer system 200 that may be used to perform these modeling processes and operations.

As shown in FIG. 2, computer system 200 may include a processor 202, a random access memory (RAM) 204, a read-only memory (ROM) 206, a console 208, input devices 210, network interfaces 212, a database 214, and a storage 216. It is understood that the type and number of listed devices are exemplary only and not intended to be limiting. The number of listed devices may be changed and other devices may be added.

Processor 202 may include any appropriate type of general purpose microprocessor, digital signal processor, or microcontroller. Processor 202 may execute sequences of computer program instructions to perform various processes as explained above. The computer program instructions may be loaded into RAM 204 for execution by processor 202 from read-only memory (ROM) 206, or from storage 216. Storage 216 may include any appropriate type of mass storage provided to store any type of information that processor 202 may need to perform the processes. For example, storage 216 may include one or more hard disk devices, optical disk devices, or other storage devices to provide storage space.

Console 208 may provide a graphic user interface (GUI) to display information to users of computer system 200. Console 208 may include any appropriate type of computer display device or computer monitor. Input devices 210 may be provided for users to input information into computer system 200. Input devices 210 may include a keyboard, a mouse, or other optical or wireless computer input devices, etc. Further, network interfaces 212 may provide communication connections such that computer system 200 may be accessed remotely through computer networks via various communication protocols, such as transmission control protocol/internet protocol (TCP/IP), hyper text transfer protocol (HTTP), etc.

Database 214 may contain model data and/or any information related to data records, such as training and testing data. Database 214 may include any type of commercial or customized database. Database 214 may also include analysis tools for analyzing the information in the database. Processor 202 may also use database 214 to determine and store performance characteristics of product cost process model 104.

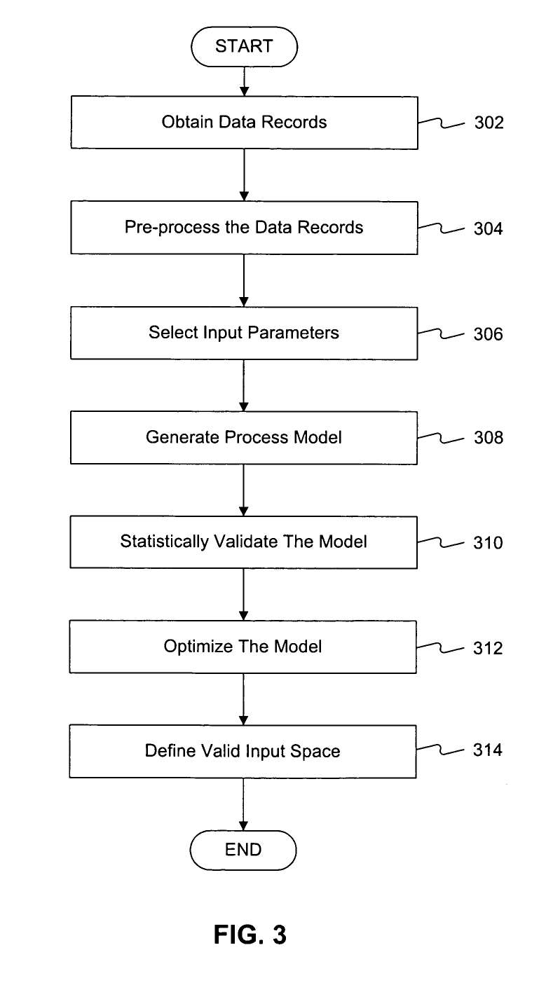

Processor 202 may perform a product cost model generation and optimization process to generate and optimize product cost process model 104. FIG. 3 shows an exemplary model generation and optimization process performed by processor 202.

As shown in FIG. 3, at the beginning of the model generation and optimization process, processor 202 may obtain data records associated with input parameters 102 and output parameters 106 (step 302). The data records may include any information characterizing a population of existing products with associated known cost. An existing product may refer to a product that exists in any appropriate form, such as a product that has been manufactured or has been designed, etc. As explained above, such products may include a single part, a component of multiple parts, an assembly, a complete manufacturing item, etc. The existing parts may include basic elements or basic parts that may be used to construct more sophisticated components. For example, a solid fluid line may be constructed using basic elements or basis parts such as a connector, elbow, fitting, flange, nut, sleeve, adaptor, block, bracket, boss, cap, collar, head, plate, plug, screw, seal, etc. Product cost associated with each of the basic parts as well as components with multiple parts may be predetermined. Product cost of the component may be closely related to the cost of involved basic elements, and/or other factors such as coupling means and processes, etc.

The existing products may be characterized by different methods involving various characteristic variables. The characteristic variables may include any information about the existing products. As not all characteristic variables may be related to product cost, input parameters 102 may only include certain characteristic variables (i.e., a subset thereof) to be used in establishing product cost process model 104.

In certain embodiments, the characteristic variables may include product attribute parameters of the products. Product attribute parameters may refer to the characteristic variables associated with the physical products or process plans. For example, product attribute parameters may include dimensional parameters, such as length, height, diameters, thickness, etc. The product attribute parameters may also include structural parameters, such as number of bends, type of flanges, etc., and/or processing parameters, such as type of material, precision tolerance, etc.

Further, cost information of the existing products may be correlated to certain product attribute parameters. These product attribute parameters of the products may be included in input parameters 102 to establish product cost process model 104. The associated cost information corresponding to the product attribute parameters may be included in output parameters 106 of product cost process model 104.

In certain other embodiments, the characteristic variables may include file descriptive parameters of the products. The file descriptive parameters may refer to various design data of the existing products from other product design environments, such as computer design tool 112. For example, instead of physical characteristics, file descriptive parameters may include file attributes of CAD files of the existing products, such as the solid fluid line and associated basic parts, etc. The CAD files may be stored by computer design tool 112 and the file descriptive parameters may be obtained based on the CAD files. Such file descriptive parameters may include, for example, file size, mass of the part, number of surfaces in the CAD file, the tightest and loosest tolerances, number of tolerances, surface areas, and/or two or three dimensional representation information and datum, etc.

These file descriptive parameters may be associated with cost information of the products. The file descriptive parameters may be included in input parameters 102 to establish product cost process model 104. The associated cost information corresponding to the product attribute parameters may also be included in output parameters 106 of product cost process model 104.

Depending on particular applications, input parameters 102 may include the product attribute parameters, the file descriptive parameters, or a combination of both types of parameters. For example, input parameters 102 may include only the product attribute parameters and product cost process model 104 may also be established based on the product attribute parameters. Input parameters 102 may also include only file descriptive parameters and product cost process model 104 may be established based on the file descriptive parameters.

Further, input parameters 102 may include both product attribute parameters and the file descriptive parameters and may be used to establish product cost process model 104 based on both parameters. Alternatively, more than one product cost process models may be established based on different parameters and may be used in parallel.

The data records may also include training data used to build product cost process model 104 and testing data used to validate product cost process model 104. In addition, the data records may also include simulation data used to observe and optimize product cost process model 104.

The data records may also reflect other characteristics of input parameters 102 and output parameters 106, such as statistic distributions, normal ranges, and/or error tolerances, etc. Once the data records are obtained (step 302), processor 202 may pre-process the data records to clean up the data records for obvious errors and to eliminate redundancies (step 304). Processor 202 may remove approximately identical data records and/or remove data records that are out of a reasonable range in order to be meaningful for model generation and optimization. After the data records have been pre-processed, processor 202 may select proper input parameters by analyzing the data records (step 306).

As explained above, the data records may be associated with many characteristic variables, which may also be referred as input variables when processor 202 selects input parameters 102 from these variables. The number of input variables may be greater than the number of input parameters 102 used for product cost process model 104, that is, input parameters 102 may be a subset of the input variables. However, it may be difficult to determine correlation between individual input variables and to select a subset of the input variables as input parameters 102.

In certain situations, the number of input variables in the data records may exceed the number of the data records and lead to sparse data scenarios. Some of the extra input variables may have to be omitted in certain mathematical models. The number of the input variables may need to be reduced to create mathematical models within practical computational time limits.

Processor 202 may select input parameters 102 according to predetermined criteria. For example, processor 202 may choose input parameters 102 by experimentation and/or expert opinions. Alternatively, in certain embodiments, processor 202 may select input parameters based on a mahalanobis distance between a normal data set and an abnormal data set of the data records. The normal data set and abnormal data set may be defined by processor 202 using any appropriate method. For example, the normal data set may include characteristic data associated with input parameters 102 that produce desired output parameters. On the other hand, the abnormal data set may include any characteristic data that may be out of tolerance or may need to be avoided. The normal data set and abnormal data set may be predefined by processor 202.

Mahalanobis distance may refer to a mathematical representation that may be used to measure data profiles based on correlations between parameters in a data set. Mahalanobis distance differs from Euclidean distance in that mahalanobis distance takes into account the correlations of the data set. Mahalanobis distance of a data set X (e.g., a multivariate vector) may be represented as
MDᵢ=(Xᵢ−μₓ)Σ⁻¹(Xᵢ−μₓ)′ (1)
where μₓ is the mean of X and Σ⁻¹ is an inverse variance-covariance matrix of X. MDᵢ weights the distance of a data point Xᵢ from its mean μₓ such that observations that are on the same multivariate normal density contour will have the same distance. Such observations may be used to identify and select correlated parameters from separate data groups having different variances.

Processor 202 may select a desired subset of input variables such that the mahalanobis distance between the normal data set and the abnormal data set is maximized or optimized. A genetic algorithm may be used by processor 202 to search input parameters 102 for the desired subset with the purpose of maximizing the mahalanobis distance. Processor 202 may select a candidate set of input parameters 102 based on a predetermined criteria and calculate a mahalanobis distance MDₙₒᵣₘₐₗ of the normal data set and a mahalanobis distance MD_{abnormal} of the abnormal data set. Processor 202 may also calculate the mahalanobis distance between the normal data set and the abnormal data (i.e., the deviation of the mahalanobis distance MDₓ=MDₙₒᵣₘₐₗ−MD_{abnormal}). Other types of deviations, however, may also be used.

Processor 202 may select the candidate subset of input variables if the genetic algorithm converges (i.e., the genetic algorithm finds the maximized or optimized mahalanobis distance between the normal data set and the abnormal data set corresponding to the candidate subset). If the genetic algorithm does not converge, a different candidate subset of input variables may be created for further searching. This searching process may continue until the genetic algorithm converges and a desired subset of input variables (e.g., input parameters 102) is selected.

After selecting input parameters 102 (e.g., length, height, diameters, thickness, number of bends, type of flanges, type of material, precision tolerance, etc., and/or file size, mass, number of surfaces, the tightest and loosest tolerances, number of tolerances and datum, etc.), processor 202 may generate product cost process model 104 to build interrelationships between input parameters 102 and output parameters 106 (e.g., product cost, etc.) (step 308). In certain embodiments, product cost process model 104 may correspond to a computational model, such as, for example, a computational model built on any appropriate type of neural network. The type of neural network computational model that may be used may include back propagation, feed forward models, cascaded neural networks, and/or hybrid neural networks, etc. Particular type or structures of the neural network used may depend on particular applications. Other types of computational models, such as linear system or non-linear system models, etc., may also be used.

The neural network computational model (i.e., product cost process model 104) may be trained by using selected data records. For example, the neural network computational model may include a relationship between output parameters 106 (e.g., product cost, etc.) and input parameters 102 (e.g., length, height, diameters, thickness, number of bends, type of flanges, type of material, precision tolerance, etc., and/or file size, mass, number of surfaces, the tightest and loosest tolerances, number of tolerances and datum, etc.). The neural network computational model may be evaluated by predetermined criteria to determine whether the training is completed. The criteria may include desired ranges of accuracy, time, and/or number of training iterations, etc.

After the neural network has been trained (i.e., the computational model has initially been established based on the predetermined criteria), processor 202 may statistically validate the computational model (step 310). Statistical validation may refer to an analyzing process to compare outputs of the neural network computational model with actual or expected outputs to determine the accuracy of the computational model. Part of the data records may be reserved for use in the validation process.

Alternatively, processor 202 may also generate simulation or validation data for use in the validation process. This may be performed either independently of a validation sample or in conjunction with the sample. Statistical distributions of inputs may be determined from the data records used for modeling. A statistical simulation, such as Latin Hypercube simulation, may be used to generate hypothetical input data records. These input data records are processed by the computational model, resulting in one or more distributions of output characteristics. The distributions of the output characteristics from the computational model may be compared to distributions of output characteristics observed in a population. Statistical quality tests may be performed on the output distributions of the computational model and the observed output distributions to ensure model integrity.

Once trained and validated, product cost process model 104 may be used to predict values of output parameters 106 when provided with values of input parameters 102. Further, processor 202 may optimize product cost process model 104 by determining desired distributions of input parameters 102 based on relationships between input parameters 102 and desired distributions of output parameters 106 (step 312).

Processor 202 may analyze the relationships between desired distributions of input parameters 102 and desired distributions of output parameters 106 based on particular applications. For example, processor 202 may select desired ranges for output parameters 106 (e.g., desired product cost, etc.). Processor 202 may then run a simulation of the computational model to find a desired statistical distribution for an individual input parameter. That is, processor 202 may separately determine a distribution (e.g., mean, standard variation, etc.) of the individual input parameter corresponding to the normal ranges of output parameters 106. After determining respective distributions for all individual input parameters, processor 202 may combine the desired distributions for all the individual input parameters to determine desired distributions and characteristics for overall input parameters 102.

Alternatively, processor 202 may identify desired distributions of input parameters 102 simultaneously to maximize the possibility of obtaining desired outcomes. In certain embodiments, processor 202 may simultaneously determine desired distributions of input parameters 102 based on zeta statistic. Zeta statistic may indicate a relationship between input parameters, their value ranges, and desired outcomes. Zeta statistic may be represented as

$$ζ = {\sum }_{1}^{j} {\sum }_{1}^{i} \vert {S}_{ij} \vert ( \frac{{σ}_{i}}{{\overline{x}}_{i}} ) ( \frac{{\overline{x}}_{j}}{{σ}_{j}} ) ,$$

where x̅ᵢ represents the mean or expected value of an ith input; x̅ⱼ represents the mean or expected value of a jth outcome; σᵢ represents the standard deviation of the ith input; σⱼ represents the standard deviation of the jth outcome; and |Sᵢⱼ| represents the partial derivative or sensitivity of the jth outcome to the ith input.

Under certain circumstances, x̅ᵢ may be less than or equal to zero. A value of 3σᵢ may be added to x̅ᵢ to correct such problematic condition. If, however, x̅ᵢ is still equal zero even after adding the value of 3σᵢ, processor 202 may determine that σᵢ may be also zero and that the process model under optimization may be undesired. In certain embodiments, processor 202 may set a minimum threshold for σᵢ to ensure reliability of process models. Under certain other circumstances, σᵢ may be equal to zero. Processor 202 may then determine that the model under optimization may be insufficient to reflect output parameters within a certain range of uncertainty. Processor 202 may assign an indefinite large number to ζ.

Processor 202 may identify a desired distribution of input parameters 102 such that the zeta statistic of the neural network computational model (i.e., product cost process model 104) is maximized or optimized. An appropriate type of genetic algorithm may be used by processor 202 to search the desired distribution of input parameters with the purpose of maximizing the zeta statistic. Processor 202 may select a candidate set of values of input parameters 102 with predetermined search ranges and run a simulation of product cost process model 104 to calculate the zeta statistic parameters based on input parameters 102, output parameters 106, and the neural network computational model. Processor 202 may obtain x̅ᵢ and σᵢ by analyzing the candidate set of input parameters 102, and obtain x̅ⱼ and σⱼ by analyzing the outcomes of the simulation. Further, processor 202 may obtain |Sᵢⱼ| from the trained neural network as an indication of the impact of the ith input on the jth outcome.

Processor 202 may select the candidate set of values of input parameters 102 if the genetic algorithm converges (i.e., the genetic algorithm finds the maximized or optimized zeta statistic of product cost process model 104 corresponding to the candidate set of values of input parameters). If the genetic algorithm does not converge, a different candidate set of input parameters 102 may be created by the genetic algorithm for further searching. This searching process may continue until the genetic algorithm converges and a desired set of values of input parameters 102 is identified. Processor 202 may further determine desired distributions (e.g., mean and standard deviations) of input parameters 102 based on the desired set of values of input parameters 102. Once the desired distributions are determined, processor 202 may define a valid input space that may include any input parameter within the desired distributions (step 314).

In one embodiment, statistical distributions of certain input parameters may be impossible or impractical to control. For example, an input parameter may be associated with a physical attribute of a product, such as size of the product, or the input parameter may be associated with a constant variable within product cost process model 104 itself. These input parameters may be used in the zeta statistic calculations to search or identify desired distributions for other input parameters corresponding to constant values and/or statistical distributions of these input parameters.

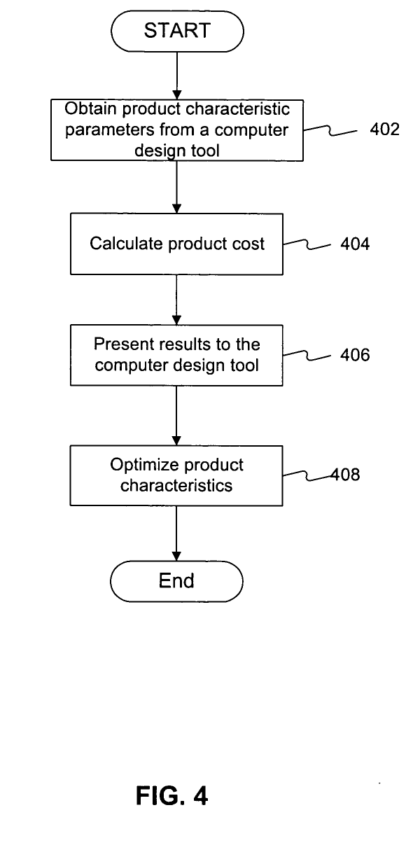

Returning to FIG. 1, after product cost process model 104 is trained, validated, and optimized, an product cost process model 104 may be used to predict cost information of a product during, for example, a design process of the product. Processor 202 may perform an operational process to provide cost information to computer design tool 112. For example, processor 202 may provide product cost 110 based on product cost process model 104 and product characteristic parameters 108 (e.g., product attribute parameters, file descriptive parameters, and/or a combination of both parameters, etc.). FIG. 4 shows an exemplary operational process performed by processor 202.

Processor 202 may receive product characteristic parameters 108 from computer design tool 112 (step 402). Depending on a particular design application, processor 202 may receive product attribute parameters as product characteristic parameters 108 of the product under design. That is, when a user of computer design tool 112 is designing the product, such as the solid fluid line, the user may cause computer design tool 112 to compose product attribute parameters of the product, such as length, height, diameters, thickness, number of bends, type of flanges, type of material, precision tolerance, etc., and send the product attribute parameters to processor 202.

Alternatively, computer design tool 112 may compose file descriptive parameters of the product, such as CAD file size, mass, number of surfaces, the tightest and loosest tolerances, number of tolerances and datum, etc., and send the file descriptive parameters as product characteristic parameters 108 to processor 202. Processor 202 may then receive file descriptive parameters of the product. Further, in certain embodiments, processor 202 may receive both the product attribute parameters and the file descriptive parameters as product characteristic parameters 108 from computer design tool 112.

After obtaining product characteristic parameters 108, processor 202 may calculate product cost 110 based on product cost process model 104 (step 404). For example, processor 202 may calculate product cost of the product based on the product attribute parameters of the product and product cost process model 104 that has been established based on product attribute parameters. Processor 202 may also calculate product cost of the product based on the file descriptive parameters of a CAD file of the product and product cost process model 104 that has been established based on file descriptive parameters.

Alternatively, processor 202 may calculate product cost of the product based on both the product attribute parameters and the file descriptive parameters of the product. When both parameters are used, product cost process model 104 may also have been established based on both product attribute parameters and file descriptive parameters. Further, processor 202 may also calculate certain other statistics related to the product attribute parameters, the file descriptive parameters, and/or product cost 110, such as distributions or histograms of such data.

Processor 202 may also present results (e.g., product cost 110, etc.) of these calculations to computer design tool 112 (step 406). Processor 202 may present the results to computer design tool 112 via any appropriate interfaces between processor 202 and computer design tool 112, and may cause the results to be displayed on console 208. Computer design tool 112 may use the results in subsequent design processes, store the results in a database, and/or display the results to the user via a user interface. Alternatively, processor 202 may directly display the results on console 208.

Processor 202 may also optimize product characteristic parameters 108 to improve the design process associated with the product (step 408). For example, the user of computer design tool 112 may limit the product cost of a certain product to a desired value or a desired range of values. Computer design tool 112 may communicate the desired value or the desired range of values of product cost 110 to processor 202. Processor 202 may identify desired values of certain or all product characteristic parameters 108 of the product. That is, processor 202 may modify product characteristic parameters 108 based on the desired value or the desired range of values of product cost 110. Processor 202 may modify such parameters based on zeta statistic, as explained in above sections. A new set of values of product characteristic parameters 108 may be identified such that the corresponding product cost may be within the desired product cost range or may be closer to the desired product cost range.

### INDUSTRIAL APPLICABILITY

The disclosed systems and methods may provide efficient and accurate product cost prediction without explicitly defining traditional product cost factors such as surface fittings or process plans. More particularly, the disclosed systems and methods may provide practical solutions when process models are difficult to build using other techniques due to computational complexities and limitations. Further, the disclosed systems and methods may derive the product cost from product characteristic parameters simultaneously, thereby potentially substantially minimizing computation requirements. Real-time product cost feedback approaches may be realized based on the minimized computation requirements.

The disclosed systems and methods may be integrated into other design environments, such as a CAD environment so that users of the design environment may use the disclosed systems and methods transparently (i.e., without knowing that the underlying product cost process model is established based the disclosed systems and methods). In different configurations, the disclosed systems and methods may also be used to provide such product cost process models to a plurality of design environments concurrently by, for example, using a centralized server connected to a computer network and incorporating the disclosed systems.

Manufacturers or other organizations may use the disclosed systems and methods, or any part thereof, to internally assist manufacturing processes and/or related design processes by accurately predicting product cost for manufacturing items. Parameters other than explained in this disclosure (e.g., product attribute parameters, file descriptive parameters, etc.) may also used with the disclosed systems and methods, as will be recognized by those skilled in the art.

Further, computer software providers may also use the disclosed systems and methods to improve computer design tools by incorporating the product cost prediction features into the computer design tools as add-ons or value enhancing services.

Other embodiments, features, aspects, and principles of the disclosed exemplary systems will be apparent to those skilled in the art and may be implemented in various environments and systems.

What is claimed is:

1. A method for a product cost modeling system, comprising:
establishing a product cost process model indicative of interrelationships between product costs of one or more existing products and a respective plurality of characteristic parameters of the existing products;
obtaining a set of values corresponding to a plurality of characteristic parameters of a target product from a data source; and
calculating the product cost of the target product based upon the set of values corresponding to the plurality of characteristic parameters of the target product and the product cost process model.

2. The method according to claim 1, further including:
presenting the product cost of the target product to the data source.

3. The method according to claim 1, further including:
determining a desired product cost range of the target product; and
modifying the plurality of characteristic parameters of the target product simultaneously such that an actual product cost of the target product is within the desired product cost range.

4. The method according to claim 1, wherein the data source is a computer aided design (CAD) environment.

5. The method according to claim 1, wherein the plurality of characteristic parameters include product attribute parameters indicative of physical attributes of the target product.

6. The method according to claim 1, wherein the plurality of characteristic parameters include file descriptive parameters indicative of file attributes of a CAD file corresponding to the target product.

7. The method according to claim 1, wherein the plurality of characteristic parameters include both product attribute parameters indicative of physical attributes of the target product and file descriptive parameters indicative of file attributes of a CAD file corresponding to the target product.

8. The method according to claim 1, wherein the establishing includes:
obtaining data records associated with the product costs of the products and characteristic variables of the products;
selecting the plurality of characteristic parameters from the characteristic variables;
generating a computational model indicative of the interrelationships between product costs of one or more products and a respective plurality of characteristic parameters of the products;
determining desired statistical distributions of the plurality of characteristic parameters of the computational model; and
recalibrating the plurality of characteristic parameters based on the desired statistical distributions.

9. The method according to claim 8, wherein selecting further includes:
pre-processing the data records; and
using a genetic algorithm to select the plurality of characteristic parameters from the characteristic variables based on a mahalanobis distance between a normal data set and an abnormal data set of the data records.

10. The method according to claim 8, wherein generating further includes:
creating a neural network computational model;
training the neural network computational model using the data records; and
validating the neural network computation model using the data records.

11. The method according to claim 8, wherein determining further includes:
determining a candidate set of the characteristic parameters with a maximum zeta statistic using a genetic algorithm; and
determining the desired distributions of the characteristic parameters based on the candidate set,
wherein the zeta statistic ζ is represented by:
$$ζ = {\sum }_{1}^{j} {\sum }_{1}^{i} \vert {S}_{ij} \vert ( \frac{{σ}_{i}}{{\overline{x}}_{i}} ) ( \frac{{\overline{x}}_{j}}{{σ}_{j}} ) ,$$
provided that x̅ᵢ represents a mean of an ith input; x̅ⱼ represents a mean of a jth output; σᵢ represents a standard deviation of the ith input; σⱼ represents a standard deviation of the jth output; and |Sᵢⱼ| represents sensitivity of the jth output to the ith input of the computational model.

12. A computer system, comprising:
a database containing data records associating product costs of one or more existing products and a respective plurality of characteristic parameters of the existing products;
a data source; and
a processor configured to:
establish a product cost process model indicative of interrelationships between the product costs and the plurality of characteristic parameters of the existing products;
obtain a set of values corresponding to a plurality of characteristic parameters of a target product from the data source;
calculate the product cost of the target product based upon the set of values corresponding to the plurality of characteristic parameters of the target product and the product cost process model;
present the product cost of the target product to the data source;
determine a desired product cost range of the target product; and
modify the plurality of characteristic parameters of the target product simultaneously such that an actual product cost of the target product is within the desired product cost range.

13. The computer system according to claim 12, wherein the data source is a computer aided design (CAD) environment.

14. The method according to claim 12, wherein the data records include at least one of product attribute parameters indicative of physical attributes of the target product and file descriptive parameters indicative of file attributes of a CAD file corresponding to the target product.

15. The computer system according to claim 12, wherein, to establish the product process model, the processor is further configured to:
obtain data records associated with the product costs of the products and characteristic variables of the products;
select the plurality of characteristic parameters from the characteristic variables;
generate a computational model indicative of the interrelationships between product costs of one or more products and a respective plurality of characteristic parameters of the products;
determine desired statistical distributions of the plurality of characteristic parameters of the computational model; and
recalibrate the plurality of characteristic parameters based on the desired statistical distributions.

16. The computer system according to claim 15, wherein, to select the plurality of characteristic parameters, the processor is further configured to:
pre-process the data records; and
use a genetic algorithm to select the plurality of characteristic parameters from the characteristic variables based on a mahalanobis distance between a normal data set and an abnormal data set of the data records.

17. The computer system according to claim 15, wherein, to determine the desired statistical distributions, the processor is further configured to:
determine a candidate set of the characteristic parameters with a maximum zeta statistic using a genetic algorithm; and
determine the desired distributions of the characteristic parameters based on the candidate set,
wherein the zeta statistic ζ is represented by:
$$ζ = {\sum }_{1}^{j} {\sum }_{1}^{i} \vert {S}_{ij} \vert ( \frac{{σ}_{i}}{{\overline{x}}_{i}} ) ( \frac{{\overline{x}}_{j}}{{σ}_{j}} ) ,$$
provided that x̅ᵢ represents a mean of an ith input; x̅ⱼ represents a mean of a jth output; σᵢ represents a standard deviation of the ith input; σⱼ represents a standard deviation of the jth output; and |Sᵢⱼ| represents sensitivity of the jth output to the ith input of the computational model.

18. A computer-readable medium for use on a computer system configured to perform a product cost predicting procedure, the computer-readable medium having computer-executable instructions for performing a method comprising:
establishing a product cost process model indicative of interrelationships between product costs of one or more existing products and a respective plurality of characteristic parameters of the existing products;
obtaining a set of values corresponding to a plurality of characteristic parameters of a target product from a data source;
calculating the product cost of the target product based upon the set of values corresponding to the plurality of characteristic parameters of the target product and the product cost process model; and
presenting the product cost of the target product to the data source.

19. The computer-readable medium according to claim 18, wherein the method further includes:
determining a desired product cost range of the target product; and
modifying the plurality of characteristic parameters of the target product simultaneously such that an actual product cost of the target product is within the desired product cost range.

20. The computer-readable medium according to claim 18, wherein the establishing includes:
obtaining data records associated with the product costs of the products and characteristic variables of the products;
selecting the plurality of characteristic parameters from the characteristic variables;
generating a computational model indicative of the interrelationships between product costs of one or more products and a respective plurality of characteristic parameters of the products;
determining desired statistical distributions of the plurality of characteristic parameters of the computational model; and
recalibrating the plurality of characteristic parameters based on the desired statistical distributions.

21. The computer-readable medium according to claim 20, wherein selecting further includes:
pre-processing the data records; and
using a genetic algorithm to select the plurality of characteristic parameters from the characteristic variables based on a mahalanobis distance between a normal data set and an abnormal data set of the data records.

22. The computer-readable medium according to claim 20, wherein generating further includes:
creating a neural network computational model;
training the neural network computational model using the data records; and
validating the neural network computation model using the data records.

23. The computer-readable medium according to claim 20, wherein determining further includes:
determining a candidate set of the characteristic parameters with a maximum zeta statistic using a genetic algorithm; and
determining the desired distributions of the characteristic parameters based on the candidate set,
wherein the zeta statistic ζ is represented by:
$$ζ = {\sum }_{1}^{j} {\sum }_{1}^{i} \vert {S}_{ij} \vert ( \frac{{σ}_{i}}{{\overline{x}}_{i}} ) ( \frac{{\overline{x}}_{j}}{{σ}_{j}} ) ,$$
provided that x̅ᵢ represents a mean of an ith input; x̅ⱼ represents a mean of a jth output; σᵢ represents a standard deviation of the ith input; σⱼ represents a standard deviation of the jth output; and |Sᵢⱼ| represents sensitivity of the jth output to the ith input of the computational model.
